(19) United States
(12) Patent Application Publication
(10) Pub. No.: US 2022/0414456 A1
(43) Pub. Date: Dec. 29, 2022

(54) Using Neural Networks to Handle Watermarks in Digital Files

(71) Applicant: Advanced Micro Devices, Inc., Santa Clara, CA (US)

(72) Inventors: Nicholas P. Malaya, Austin, TX (US); William W. Freitag, JR., Austin, TX (US)

(21) Appl. No.: 17/362,661

(22) Filed: Jun. 29, 2021

(51) Int. Cl. G06N 3/08; G06N 3/04

(52) U.S. Cl. CPC G06N 3/08; G06N 3/0454

(57) ABSTRACT

The described embodiments include an electronic device having a processor. The processor performs operations for handling watermarks in files. As part of the operations, the processor processes a portion of a file in a classification neural network to determine whether a watermark is present in the portion of the file. Based on a result of the processing, the processor performs an update associated with the watermark in the portion of the file. The processor then provides the updated portion of the file.

### BACKGROUND

### Related Art

Entities often desire to include information in digital files for purposes such as attribution, identification, access/copy rights indication, etc. For example, a photographer may take a digital photograph, i.e., create a digital image file, in which the photographer wishes to include information identifying themselves as the photographer. As another example, an engineer may draft a technical specification document for a new product, i.e., create a document file, that the engineer wishes to mark as confidential. One common technique for including this type of information in files is including watermarks in the files. Watermarks are graphical objects in files in which desired information is incorporated in the form of text, graphics, images, etc. FIG. 1 presents a block diagram illustrating a watermark 100 in a file, i.e., document 102. Document 102, which includes text 104 and image 106, is a document such as might be created using a word processing program. Watermark 100, which is placed at an angle from the bottom left to the top right of document 102, includes text that identifies the document as accessible only to employees of company ABC, Inc. and prohibits the copying of document 102. In other words, watermark 100 identifies both access and copy rights for document 102. Watermark 100 overlays text 104 and image 106 in document 102. Watermark 100 is partially transparent and/or shown in a lighter color (e.g., lighter red or grey, given black text) to enable at least some view of text 104 and image 106 despite the presence of watermark 100.

Although a particular implementation of a watermark is shown in FIG. 1, watermarks come in other arrangements and forms. For example, a watermark may be included in the margins of a document at the bottom, top, or sides of the document—and may not obscure text and/or images in the document. As another example, a watermark can be included in a file, but in a form that is essentially invisible to a human reader. For instance, a watermark may be included in digital presentation file (i.e., a file that includes a number of digital slides) via small pixel value differences in a color of text and/or image in some or all of the slides. In these case, although all of text and/or images demonstrate very little or no outward appearance of the watermark to a human viewer, the watermark can readily be perceived by software due to specified small but regular pixel values or value differences in the text and/or images. For instance, a green channel of the pixels in which a watermark is displayed may be slightly dimmer than the green channel of pixels in which watermark is not displayed, have a specified value, etc.

Although watermarks are useful for including information in files, entities may include improper information in watermarks or may include watermarks in files that do not need watermarks. As an example of the former issue, a creator of a video may include watermarks in frames of the video that incorrectly identify a source of the video or desired audience of the video, include spelling or grammatical errors, etc.—which can defeat the purpose of including the watermarks. As an example of the latter issue, an author of a document may include a fairly intrusive watermark underlaid under text and images of the document when such a watermark is not necessary for entities that are to access the file (or “accessing entities”). In this case, the watermark can unnecessarily obscure the text and images of the document—making reading the document difficult for an accessing entity. In addition to the above-described issues, a creating entity may simply forget to include a watermark in a file, which means that the file can be missing desired, and possibly critical, information.

### BRIEF DESCRIPTION OF THE FIGURES

FIG. 1 presents a block diagram illustrating a watermark in a file.

FIG. 2 presents a block diagram illustrating a fully connected neural network in accordance with some embodiments.

FIG. 3 presents a block diagram illustrating a convolutional neural network in accordance with some embodiments.

FIG. 4 presents a block diagram illustrating an electronic device in accordance with some embodiments.

FIG. 5 presents a flowchart illustrating a process for handling a watermark in a portion of a file in accordance with some embodiments.

FIG. 6 presents a flowchart illustrating a process for removing a watermark from a portion of a file in accordance with some embodiments.

FIG. 7 presents a flowchart illustrating a process for adding a watermark to a portion of a file in accordance with some embodiments.

FIG. 8 presents a flowchart illustrating a process for updating a watermark in a portion of a file in accordance with some embodiments.

Throughout the figures and the description, like reference numerals refer to the same figure elements.

### DETAILED DESCRIPTION

The following description is presented to enable any person skilled in the art to make and use the described embodiments and is provided in the context of a particular application and its requirements. Various modifications to the described embodiments will be readily apparent to those skilled in the art, and the general principles described herein may be applied to other embodiments and applications. Thus, the described embodiments are not limited to the embodiments shown, but are to be accorded the widest scope consistent with the principles and features described herein.

### Terminology

In the following description, various terms are used for describing embodiments. The following is a simplified and general description of some of the terms. Note that these terms may have significant additional aspects that are not recited herein for clarity and brevity and thus the description is not intended to limit this these terms.

Functional block: functional block refers to a set of interrelated circuitry such as integrated circuit circuitry, discrete circuitry, etc. The circuitry is “interrelated” in that circuit elements in the circuitry share at least one property. For example, the circuitry may be included in, fabricated on, or otherwise coupled to a particular integrated circuit chip, substrate, circuit board, or portion thereof, may be involved in the performance of specified operations (e.g., computational operations, control operations, memory operations, etc.), may be controlled by a common control element and/or a common clock, etc. The circuitry in a functional block can have any number of circuit elements, from a single circuit element (e.g., a single integrated circuit logic gate or discrete circuit element) to millions or billions of circuit elements (e.g., an integrated circuit memory). In some embodiments, functional blocks perform operations “in hardware,” using circuitry that performs the operations without executing program code.

Portion of a file: a portion of a file includes at least part of the file, but may include all of the file. For example, a file can be a digital image file (e.g., a jpeg, bmp, or another file) and the “portion” of the file is or includes the entire file. As another example, the file can be a multipage document file (e.g., a docx, pdf, or other file) that includes an image and the “portion” of the file is or includes the image, a page of the document file, or another part of the document file. As yet another example, the file can be a digital video file with multiple digital video frames (e.g., an mp4, mov, or other file) and the “portion” of the file is or includes one or more of the digital video frames. As yet another example, the file can be a digital presentation file having multiple slides (e.g., a ppt, otp, or other file) and the “portion” of the file is or includes one or more of the slides.

### Neural Networks

In the described embodiments, an electronic device performs operations for artificial neural networks or, more simply, “neural networks.” Generally, a neural network is a computational structure that includes internal elements having similarities to biological neural networks, such as those associated with a living creature's brain. Neural networks can be trained to perform specified tasks by using known instances of training data to configure the internal elements of the neural network so that the neural network can perform the specified task on unknown instances of input data. For example, one task performed by neural networks is identifying whether (or not) an image includes image elements such as a watermark, faces, or vehicles. When training a neural network to perform image identification, images that are known to include (or not) the image element are processed through the neural network to configure the internal elements to generate appropriate outputs when subsequently processing unknown images to identify whether the image elements are present in the unknown images.

Depending on the nature and arrangement of the internal elements of a neural network, the neural network can be a “classification” network or a “generative” network. A classification network is a neural network that is configured to process instances of input data and output results that indicate whether specified patterns are likely to be present in the instances of input data. For example, a classification network may be configured to output results indicating whether image elements are likely present in digital images, whether particular words or phrases are likely present in digital audio, etc. Such neural networks are called classification (or “discriminative”) neural networks because they classify instances of input data as having the specified pattern (or not). A generative network, in contrast, is a neural network that is configured to generate instances of output data that include patterns having similarity to specified patterns. For example, the generative network may be configured to generate digital images that include patterns similar to given watermarks, faces, or road signs; audio that includes patterns similar to particular sounds or words, etc.

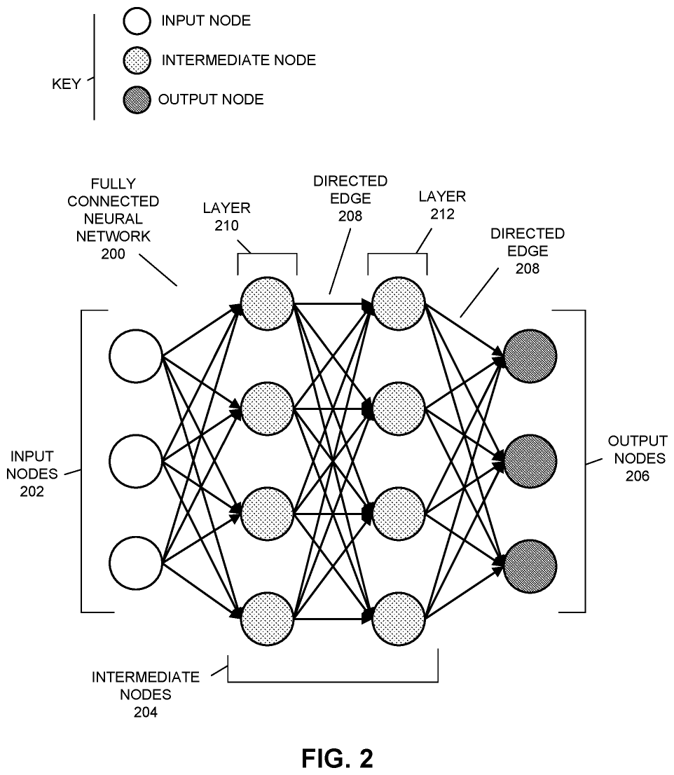

One type of neural network is a “fully connected” neural network. Fully connected neural networks include, in their internal elements, a set of artificial neurons, or “nodes,” that are interconnected with one another in an arrangement having some similarity to how neurons are interconnected via synapses in a living creature's brain. A fully connected neural network can be visualized as a form of weighted graph structure in which the nodes include input nodes, intermediate (or “hidden”) nodes, and output nodes. FIG. 2 presents a block diagram illustrating a fully connected neural network 200 in accordance with some embodiments. Fully connected neural network 200 includes input nodes 202, intermediate nodes 204 in layers 210 and 212, output nodes 206, and directed edges 208 (only two directed edges and layers are labeled for clarity). Within the fully connected neural network, each node other than output nodes 206 is connected to one or more downstream nodes via a directed edge that has an associated weight. During operation, input nodes 202 in a first layer of fully connected neural network 200 receive inputs from an external source and process the inputs to produce input values. Input nodes 202 forward the input values to intermediate nodes 204 in the next layer 210 of fully connected neural network 200. The receiving intermediate nodes 204 weight the received inputs based on a weight of a corresponding directed edge, i.e., adjust the received inputs such as multiplying by a weighting value, etc. Each intermediate node 204 sums the corresponding weighted received inputs and possibly a bias value to generate an internal value and evaluates an activation function for that intermediate node 204 using the internal value to produce a result value. Intermediate nodes 204 then forward the result values as input values to intermediate nodes 204 in the next layer 212 of fully connected neural network 200, where the input values are used to generate internal values and evaluate an activation function as described above. In this way, values progress through intermediate nodes 204 in layers of fully connected neural network 200 until a last layer of intermediate nodes 204 forward result values to output nodes 206 for fully connected neural network 200, which generate outputs for fully connected neural network 200. Continuing the example above, the outputs produced by output nodes 206—and thus from fully connected neural network 200—can be in a form, e.g., a number between 0-1, that indicates whether or not an image is likely to include (or not) the specified image element. Alternatively, the outputs produced by output nodes 206 can be other values, e.g., pixel values in an image generated by fully-connected neural network 200, etc.

As described above, values forwarded along directed edges between nodes in a fully connected neural network (e.g., fully connected neural network 200) are weighted in accordance with a weight associated with each directed edge. By setting the weights associated with the directed edges during a training process so that desired outputs are generated by the fully connected neural network, the fully connected neural network can be trained to produce intended outputs such as the above-described identification of image elements in images. When training a fully connected neural network, numerous instances of training data having expected outputs are processed in the fully connected neural network to produce actual outputs from the output nodes. Continuing the example above, the instances of training data would include digital images that are known to include (or not) particular image elements, and thus for which the fully connected neural network is expected to produce outputs that indicate that the image element is likely present (or not) in the images. After each instance of training data is processed in the fully connected neural network to produce an actual output, an error value, or “loss,” between the actual output and a corresponding expected output is calculated using mean squared error, log loss, or another algorithm. The loss is then worked backward through the fully connected neural network, or “backpropagated” through the fully connected neural network, and used to adjust the weights associated with the directed edges in the fully connected neural network in order to reduce the error for the instance of training data. The backpropagation operation adjusts the fully connected neural network's response for that particular instance of training data and all subsequent instances of input data. For example, one backpropagation technique, which can be called gradient descent, involves computing a gradient of the loss with respect to the weight for each directed edge in the fully connected neural network. Each gradient is then multiplied by a training coefficient or “learning rate” to compute a weight adjustment value. The weight adjustment value is next used in calculating an updated value for the corresponding weight, e.g., added to an existing value for the corresponding weight.

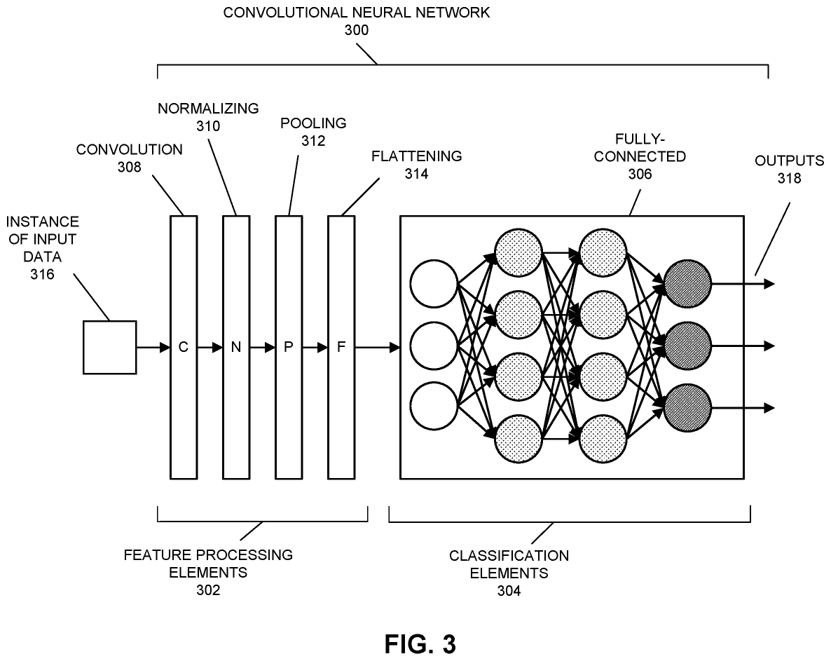

Another type of neural network is a “convolutional” neural network. FIG. 3 presents a block diagram illustrating convolutional neural network 300 in accordance with some embodiments. As can be seen in FIG. 3, the internal elements of convolutional neural network 300 can be grouped into feature processing elements 302 and classification elements 304. Feature processing elements 302 process features in instances of input data 316 (e.g., digital images, digital audio recordings, etc.) in preparation for the classification of the features in classification elements 204. Feature processing elements 302 include internal elements for convolution, normalizing, and pooling. In the convolution 308 internal elements, a set of filters are used to generate feature maps from instances of input data. The feature maps are then normalized (e.g., using rectified linear units) in the normalizing 310 internal elements. After being processed in the normalizing 310 internal elements, the feature maps are further processed (e.g., subsampled, downsampled, etc.) in the pooling 312 internal elements to generate reduced-dimension feature maps. Flattening 314 internal elements next prepare the reduced-dimension feature maps from the pooling 312 internal elements for input into the fully connected 306 internal elements. Classification elements 304 include a fully connected 306 neural network (similar to the fully-connected neural network described above) that classifies inputs (i.e., flattened reduced-dimension feature maps) as including specified elements (or not) and produces outputs 318 representing the classification. As with the fully connected neural network, backpropagation (i.e., gradient descent, etc.) can be used to train the convolution 308 internal elements by adjusting values in the set of filters and possibly other values in the internal elements of feature processing elements 302.

Although examples of neural networks are presented in FIGS. 2-3, in some embodiments, a different arrangement of nodes and/or layers is present in a given neural network. For example, a fully connected neural networks—including those found within convolutional neural networks—can have thousands or millions of nodes arranged in large numbers of layers. In addition, the feature processing elements for convolutional neural networks may have multiple/repeated layers of convolution, normalizing, and pooling internal elements. The examples in FIGS. 2-3 are also generic; fully connected and/or convolutional neural networks may include different arrangements of internal elements and/or internal elements that are not shown in FIGS. 2-3. Moreover, although fully connected and convolutional neural networks are presented as examples, in some embodiments, different type(s) of neural network(s) are used. For example, in some embodiments, one or more of recurrent neural networks, auto encoders, Markov chains, belief networks, and residual networks may be used alone or in combination with other neural networks. Generally, the described embodiments are operable with any configuration of neural network(s) that can perform the operations herein described.

### Watermarks

In the described embodiments, files such as word processor documents, digital images, digitally encoded videos, etc. can include watermarks. Generally, watermarks are graphical objects in portions of files (e.g., on pages of a document file or presentation slides in a digital presentation file) with text, graphics, images, etc. that include or represent information about or associated with the portions of the files. For example, in some embodiments, watermarks include attribution information that can be used to directly or indirectly determine an author, creator, or other source of portions of files. As another example, in some embodiments, watermarks include access and/or copy rights information for portions of files, such as identifiers of accessing entities that are permitted to read and/or copy the portions of the files.

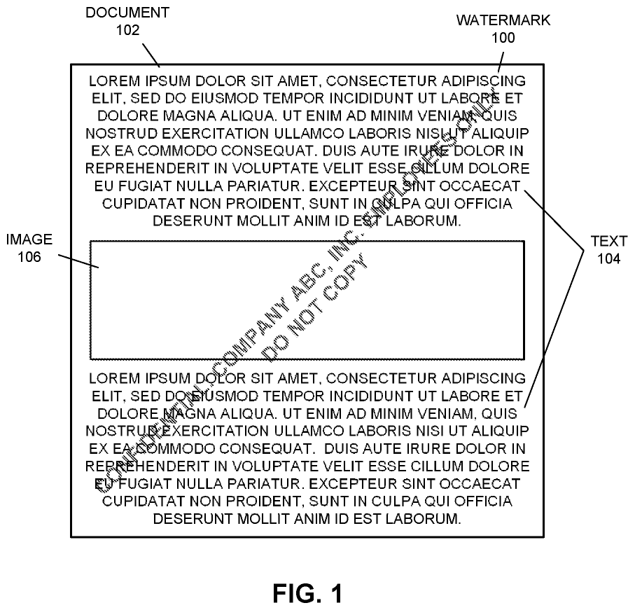

In some embodiments, watermarks are human visible graphical objects in files in which desired information can be relatively readily perceived by human readers. An example of such a watermark is watermark 100 as shown in FIG. 1, which includes text that identifies access and copy rights for a document 102. In some embodiments, however, watermarks are graphical objects that are not readily perceived by humans—and may be virtually invisible to humans. For example, a watermark may be included in a document file having text and/or images via small designated pixel value differences in a color of the text and/or images in the document. In other words, the watermark may be “encoded” or “hidden within” existing information in the document with pixels of the text and images having specified values or local differences in values defining the watermark. Generally, the described embodiments can operate on and with any form of watermark that can be identified in portions of files as described herein.

### Overview

The described embodiments perform operations for handling watermarks in files such as word processor documents, digital presentation slides, frames in digitally encoded videos, etc. In the described embodiments, a processor processes a portion of a file (which can, as described above, include the entire file or some part thereof) in a classification neural network to determine whether a watermark is present in the portion of the file. In other words, the processor uses the portion of the file as input to the classification neural network and the portion of the file is processed through the classification neural network to generate a result indicating whether (or not) a given watermark is likely present in the portion of the file. The processor then uses the result to determine that a given update associated with the watermark is to be made to the portion of the file. For example, the processor can determine that the watermark is to be removed, updated, or, in the case where no watermark is found in the portion of the file, added to the portion of the file. The processor then provides the portion of the file for subsequent use, such as by providing the portion of the file for streaming, storing the portion of the file in memory, or presenting the portion of the file for viewing by a user.

In some embodiments, for removing a watermark from a portion of a file, the processor processes the portion of the file in a generative neural network to generate an output portion of the file without the watermark. That is, the processor uses the portion of the file as input to the generative neural network and the portion of the file is processed through the generative neural network to generate a version of the portion of the file without the watermark. For example, for a watermark similar to watermark 100, the generative neural network removes watermark 100 from the portion of the file (i.e., document 102). In some embodiments, as part of removing a watermark, the generative neural network retains and/or recreates human visible information such as text and images that is obscured by the watermark in a portion of a file (to at least some extent). Continuing the example, when watermark 100 is removed, text 104 (e.g., the words LABORE and VENIAM at the top right of document 102) is retained or recreated, as are parts of image 106 obscured by watermark 100.

In some embodiments, for correcting a watermark in a portion of a file, the processor replaces existing information in the watermark with new information—or simply replaces the entire watermark. Continuing the example from FIG. 1, assuming that the text MNO, INC. should be present in the watermark 100 instead of ABC, INC., the processor replaces ABC, INC. in watermark 100 with MNO, INC. For this operation, the processor first acquires watermark information from the watermark. For example, in some embodiments the classification neural network or another/different classification neural network can be used to extract the watermark from the portion of the file. The extracted watermark can then be processed to determine words in text and/or other information from the watermark—which can be done in the neural network or using a recognition program (e.g., optical character recognition, etc.). The processor then compares the watermark information to an information template to determine whether the watermark information matches the information template. Continuing the example, the processor can determine whether watermark 100 includes MNO, INC.—which it does not. When the watermark information does not match the information template, the processor processes the portion of the file in a generative neural network to replace the watermark with a given watermark. Again continuing the example, the processor can replace ABC, INC. with MNO, INC. In some embodiments, when updating the watermark, the processor retains and/or recreates human visible information such as text and images that is obscured by the watermark in the portion of the file (to the extent possible).

In some embodiments, for adding the watermark to a portion of a file (i.e., when a watermark is not already present in the portion of the file), the processor adds new watermark information to the portion of the file. For example, in some embodiments, the processor processes the portion of the file through a generative neural network to add a specified watermark to the portion of the file. As another example, in some embodiments, the processor processes the portion of the file through a watermarking application (e.g., through a word processing application, etc.) to add a given watermark to the portion of the file.

In some embodiments, before adding, changing, or removing a watermark in a portion of a file, the processor ensures that such a change to the portion of the file is permitted in view of security settings. For example, in some embodiments, before removing the watermark, the processor checks a listing of accessing entities to ensure that a given accessing entity to whom the portion of the file is to be subsequently provided is permitted to access the portion of the file without the watermark. As another example, in some embodiments, the processor determines an accessing entity that is subsequently to have access to the portion of the file (e.g., via a configuration setting, input from a user, etc.) and makes the changes to the watermark in the portion of the file accordingly. For instance, the processor can include a watermark directed to a particular accessing entity.

In some embodiments, after updating a portion of a file, the processor updates one or more other portions of the file based at least in part on the update to the portion of the file. For example, in some embodiments, the processor can update a watermark on a particular frame of video in a stream of frames of video (i.e., the portion of the file) and then use the knowledge of the location and content of the watermark in the particular frame of video for updating subsequent frames of video in the stream of frames of video (i.e., the one or more other portions of the file). In some embodiments, the processor does this without performing at least some operations for updating the one or more other portions that were initially performed for the portion of the file, such as processing the portion of the file in the classification neural network to determine whether a watermark is present. In other words, once a watermark is found (or not) in the portion of the file, the same watermark is assumed to be present (or not) in other portions of the file and operations are performed accordingly.

By adding and updating watermarks in portions of files, the described embodiments can ensure that the information about or associated with the portions of the files included in the watermarks is present, accurate, and timely. This can ensure that the watermarks better inform accessing entities of access and copy rights for portions of files, etc. By removing watermarks from portions of files, the described embodiments can avoid the watermarks obscuring information in the portions of the files and make the portions of the files easier for accessing entities to read (or otherwise access). By improving the handling of watermarks, the described embodiments improve the performance of electronic devices that handle the watermarks, which can increase user satisfaction with the electronic devices.

### Electronic Device

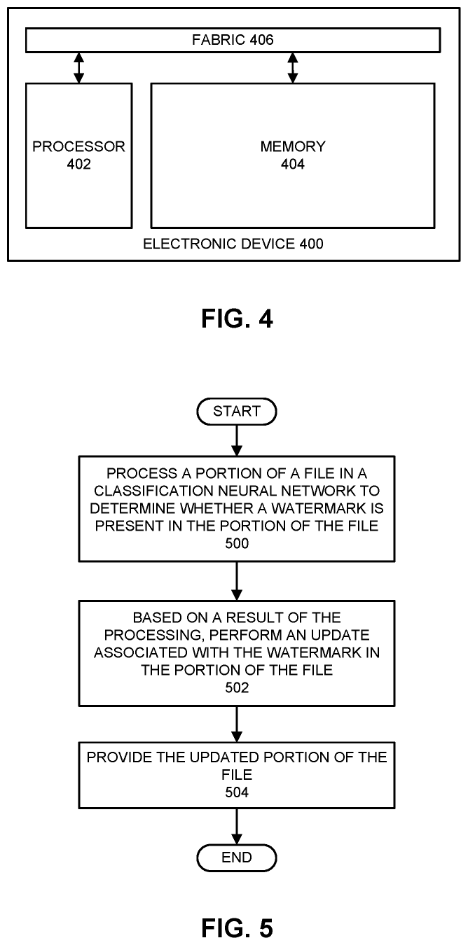

FIG. 4 presents a block diagram illustrating electronic device 400 in accordance with some embodiments. As can be seen in FIG. 4, electronic device 400 includes processor 402, memory 404, and fabric 406. Processor 402, memory 404, and fabric 406 are all implemented in “hardware,” i.e., using corresponding integrated circuitry, discrete circuitry, and/or devices. For example, in some embodiments, processor 402, memory 404, and fabric 406 are implemented in integrated circuitry on one or more semiconductor chips; are implemented in a combination of integrated circuitry on one or more semiconductor chips in combination with discrete circuitry and/or devices; or are implemented in discrete circuitry and/or devices. In the described embodiments, processor 402, memory 404, and/or fabric 406 perform operations for handling watermarks in digital files (e.g., document files, image files, etc.)—using classifier and/or generative neural networks for at least some of the operations. In some embodiments, processor 402, memory 404, and/or fabric 406 perform these operations “in hardware.” For example, in some embodiments, processor 402, memory 404, and/or fabric 406 include circuitry having integrated circuits, discrete circuit elements, and/or devices that perform respective parts of the described operations. In some embodiments, processor 402 executes program code for performing the operations.

Processor 402 is a functional block that performs computational, memory access, control, and/or other operations in electronic device 400. For example, in some embodiments, processor 402 is or includes one or more central processing unit (CPU) cores, graphics processing unit (GPU) cores, embedded processors, neural network processors, application specific integrated circuits (ASICs), microcontrollers, and/or other functional blocks.

Memory 404 is a functional block that is used for storing data for other functional blocks in electronic device 400. For example, in some embodiments, memory 404 is or is part of a “main” memory in electronic device 400. Memory 404 includes memory circuitry for storing data and control circuitry for handling accesses of data stored in the memory circuitry.

Fabric 406 is a functional block that performs operations for communicating information (e.g., commands, data, control signals, and/or other information) between processor 402 and memory 404 (and other functional blocks and devices in electronic device 400 (not shown)). Fabric 406 includes some or all of communication paths (e.g., busses, wires, guides, etc.), controllers, switches, routers, etc. that are used for communicating the information.

Electronic device 400 as shown in FIG. 4 is simplified for illustrative purposes. In some embodiments, however, electronic device 400 includes other functional blocks and devices for performing the operations herein described and other operations. For example, electronic device 400 can include some or all of electrical power functional blocks or devices, human interface functional blocks or devices (e.g., displays, touch sensitive input elements, speakers, etc.), input-output functional blocks or devices, etc. In addition, in some embodiments, electronic device 400 includes different numbers and/or arrangements of functional blocks and devices than what is shown in FIG. 4. For example, in some embodiments, electronic device 400 includes a different number of processors. As another example, in some embodiments, fabric 406 and/or the other communications paths are arranged differently. Generally, in the described embodiments, electronic device 400 includes sufficient numbers and/or arrangements of functional blocks to perform the operations herein described.

Electronic device 400 can be, or can be included in, any electronic device that can perform operations for handling watermarks. For example, electronic device 400 can be, or can be included in, desktop computers, laptop computers, wearable electronic devices, tablet computers, smart phones, servers, artificial intelligence apparatuses, virtual or augmented reality equipment, network appliances, toys, audio-visual equipment, home appliances, controllers, vehicles, slide presentation hardware/projectors, etc., and/or combinations thereof. In some embodiments, electronic device 400 is included on one or more semiconductor chips. For example, in some embodiments, electronic device 400 is entirely included in a single “system on a chip” (SOC) semiconductor chip, is included on one or more ASICs, etc.

### Process for Handling Watermarks in Files

In the described embodiments, functional blocks in an electronic device perform operations for handling watermarks in portions of files (which, as described above, can include the entire file or some part thereof). Generally, these operations are performed for ensuring that watermarks in the portions of the files, when present, include specified information—or that portions of files that may not need watermarks do not include watermarks. FIG. 5 presents a flowchart illustrating a process for handling a watermark in a portion of a file in accordance with some embodiments. FIG. 5 is presented as a general example of operations performed in some embodiments. In other embodiments, however, different operations are performed and/or operations are performed in a different order. Additionally, although certain elements are used in describing the process (e.g., a processor, etc.), in some embodiments, other elements perform the operations.

The process shown in FIG. 5 starts when a processor processes a portion of a file in a classification neural network to determine whether a watermark is present in the portion of the file (step 500). For this operation, the processor provides the portion of the file (or some part thereof) as an input to a classification neural network and performs the various operations of the neural network in order to generate a result value that indicates whether the portion of the file is likely to include the watermark. For example, assuming the file is a digital presentation file having multiple slides and the portion of the file includes a first slide in the file, the processor can acquire the first slide from the digital presentation file and process the first slide in the classification neural network to determine whether (or not) the first slide includes the watermark. In some embodiments, the classification neural network is a convolutional neural network. In these embodiments, among the operations performed by the classification neural network are feature processing operations and classification operations such as those described above for the convolutional neural network.

In some embodiments, although not shown in FIG. 5, processing the portion of the file in the classification neural network includes extracting the watermark and/or some part thereof from the portion of the file (assuming that the watermark is present). In other words, as part of determining whether the watermark is present in the portion of the file, the processor also retrieves the watermark from the portion of the file. In these embodiments, the classification neural network itself may extract and return the watermark—such as with a neural network that is trained to return, as a result, watermarks from files that include watermarks. Alternatively, additional processing software may be used to extract the watermark after the classification neural network determines that the watermark is present in the portion of the file. Once extracted, a watermark can be processed to acquire information from the watermark. For example, the watermark can be processed to acquire text/words/phrases, dates, graphics, etc. from the watermark. As described elsewhere herein, information acquired from a watermark can be used to determine whether the watermark includes desired information, etc.

In some embodiments, the processor (or, more generally, the electronic device) receives the classification neural network from an external source. For example, the processor may receive the classification neural network from an external source that generates and/or stores neural networks (e.g., another electronic device, a file/storage system, etc.). In these embodiments, the classification neural network has already been trained using multiple files with and/or without watermarks to determine the presence of watermarks in portions of files. In some embodiments, however, the processor itself generates the neural network. Generally, the classification neural network can be generated/trained by the processor itself and/or received (e.g., as a configuration file or other identification of the neural networks) from an external source that generates/trains and/or stores neural networks. The same is true for the other neural networks described herein.

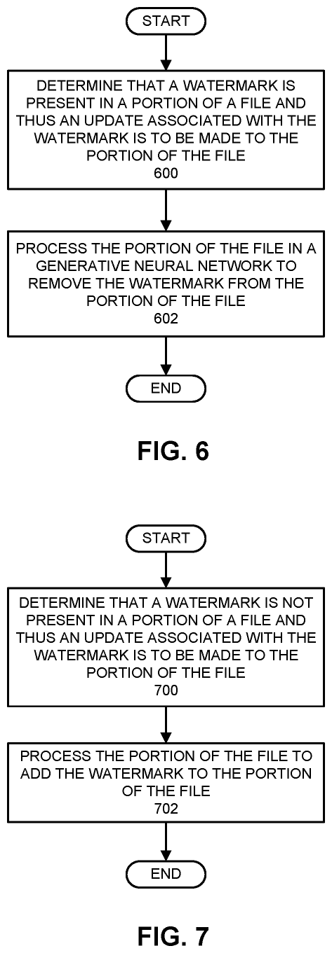

The processor then, based on a result of the processing, performs an update associated with the watermark in the portion of the file (step 502). For this operation, the processor performs an update associated with the watermark to ensure that the watermark, if any, in the portion of the file conforms with a given specification. For example, in some embodiments, the update associated with the watermark includes removing the watermark from the portion of the file when the watermark is found to be present in the portion of the file. As another example, in some embodiments, the update associated with the watermark includes adding the watermark to the portion of the file when the watermark is found not to be present in the portion of the file. As yet another example, in some embodiments, the update associated with the watermark includes updating the watermark (e.g., text, graphics, dates, etc. in the watermark) when the watermark is found to be present in the portion of the file but not to conform with an information requirement for the watermark. These operations are described in more detail below for FIGS. 6-8.

The processor then provides the updated portion of the file (step 504). For this operation, the processor makes the portion of the file as updated in step 502 available for other operations. For example, in some embodiments, the processor stores the file or the portion of the file in a memory (or in a cache memory), thereby making the file or the portion of the file available for accessing in the memory (or the cache memory). As another example, in some embodiments, the processor streams the file or the portion of the file, such as by providing the file or the portion of the file to a second electronic device via a network interface or an input-output device of the electronic device. As yet another example, in some embodiments, the processor presents the file or the portion of the file to a user, such as on a display, as an attachment to an email, etc.

Process for Removing Watermarks from Files

As described for FIG. 5, in some embodiments, upon determining that a watermark is present in a portion of a file (which, as described above, can include the entire file or some part thereof), a processor updates the portion of the file by removing the watermark from the portion of the file. FIG. 6 presents a flowchart illustrating a process for removing a watermark from a portion of a file in accordance with some embodiments. FIG. 6 is presented as a general example of operations performed in some embodiments. In other embodiments, however, different operations are performed and/or operations are performed in a different order. For example, in some embodiments, a generative neural network alone is not used for removing the watermark. For instance, image processing software may be used to assist with removing the watermark. Additionally, although certain elements are used in describing the process (e.g., a processor, etc.), in some embodiments, other elements perform the operations.

The process shown in FIG. 6 starts when a processor determines that a watermark is present in a portion of a file and thus an update associated with the watermark is to be made to the portion of the file (step 600). In some embodiments, this operation is similar to those described above for steps 500-502. In these embodiments, therefore, the processor processes the portion of the file in a classification neural network to determine whether the watermark is present in the portion of the file (the watermark is assumed to be for this example). Because the watermark is present, the processor determines that an update is to be made for the portion of the file.

The processor then processes the portion of the file in a generative neural network to remove the watermark from the portion of the file (step 602). For this operation, the processor provides the portion of the file (or some part thereof) as an input to a generative neural network and performs the various operations of the neural network in order to generate a result in which the watermark has been removed from the portion of the file. For example, assuming the file is a digital presentation file slide (i.e., an image of the slide with text, images, etc.), the processor can acquire the slide from the digital presentation file and process the slide in the generative neural network to remove the watermark. In some embodiments, the generative neural network is a fully connected neural network. In these embodiments, among the operations performed by the fully connected neural network are operations such as those described above.

In some embodiments, processing the portion of the file through the generative neural network to remove the watermark includes retaining and/or recreating human visible information wholly or partially obscured by the watermark in the portion of the file. In other words, where human visible information such as text, images, graphics, etc. was wholly or partially obscured by the watermark (e.g., text 104 and image 106 in FIG. 1), the generative neural network adds replacement human visible information so that the portion of the file appears more as the file might have without the watermark. For example, for text, the generative neural network can fill in text that was previously concealed by the watermark. In some of these embodiments, the processing is akin to or includes partial optical character recognition, word or phrase identification, retaining human visible information that can be perceived through a semitransparent watermark, etc. In some embodiments, retaining and/or recreating the human visible information helps to conceal the fact that the watermark was removed and makes human visible information in the file easier to read/view, more complete, etc. Note that, given imperfect information about human visible information underlying a watermark (e.g., where the watermark completely obscures the underlying human visible information), the replacement human visible information is necessarily an approximation. The approximation can, however, be reasonably accurate with a sufficiently trained generative neural network.

### Process for Adding Watermarks to Files

As described for FIG. 5, in some embodiments, upon determining that a watermark is not present in a portion of a file (which, as described above, can include the entire file or some part thereof), a processor updates the portion of the file by adding the watermark to the portion of the file. FIG. 7 presents a flowchart illustrating a process for adding a watermark to a portion of a file in accordance with some embodiments. FIG. 7 is presented as a general example of operations performed in some embodiments. In other embodiments, however, different operations are performed and/or operations are performed in a different order. Additionally, although certain elements are used in describing the process (e.g., a processor, etc.), in some embodiments, other elements perform the operations.

The process shown in FIG. 7 starts when a processor determines that a watermark is not present in a portion of a file and thus an update associated with the watermark is to be made to the portion of the file (step 700). In some embodiments, this operation is similar to those described above for steps 500-502. In these embodiments, therefore, the processor processes the portion of the file in a classification neural network to determine whether the watermark is present in the portion of the file (the watermark is assumed not to be for this example). Because the watermark is not present, the processor determines that an update is to be made for the portion of the file.

The processor then processes the portion of the file to add the watermark to the portion of the file (step 702). In some embodiments, for this operation, the processor provides the portion of the file (or some part thereof) as an input to a generative neural network and performs the various operations of the neural network in order to generate a result in which the watermark has been added to the portion of the file. For example, assuming the file is a digital presentation file slide (i.e., an image of the slide with text, images, etc.), the processor can acquire the slide from the digital presentation file and process the slide in the generative neural network to add the watermark. In some embodiments, the generative neural network is a fully connected neural network. In these embodiments, among the operations performed by the fully connected neural network are operations such as those described above.

Although a generative neural network might be used for adding the watermark to the portion of the file as described above, in some embodiments, a different mechanism is used for adding the watermark to the portion of the file. For example, in some embodiments, the processor provides the portion of the file (or some part thereof) as an input to a watermarking application and performs the operations of the watermarking application in order to add the watermark to the portion of the file. In some of these embodiments, the watermarking application is a software application in which the portion of the file was created. For example, assuming the portion of the file is a digital presentation file slide, the processor can acquire the slide from the digital presentation file and process the slide in a digital presentation application to add the watermark.

### Process for Updating Watermark in Files

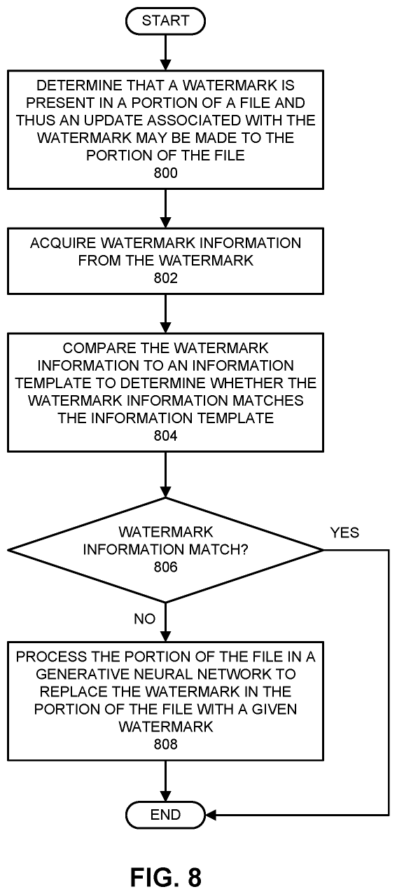

As described for FIG. 5, in some embodiments, upon determining that a watermark is present in a portion of a file (which, as described above, can include the entire file or some part thereof), a processor updates the portion of the file by updating the watermark (e.g., text, graphics, dates, etc. in the watermark) when the when the watermark is found to be present in the portion of the file but not to conform with an information requirement for the watermark. FIG. 8 presents a flowchart illustrating a process for updating a watermark in a portion of a file in accordance with some embodiments. FIG. 8 is presented as a general example of operations performed in some embodiments. In other embodiments, however, different operations are performed and/or operations are performed in a different order. Additionally, although certain elements are used in describing the process (e.g., a processor, etc.), in some embodiments, other elements perform the operations.

The process shown in FIG. 8 starts when a processor determines that a watermark is present in a portion of a file and thus an update associated with the watermark may be made to the portion of the file (step 600). In some embodiments, this operation is similar to those described above for steps 500-502. In these embodiments, therefore, the processor processes the portion of the file in a classification neural network to determine whether the watermark is present in the portion of the file (the watermark is assumed to be for this example). Because the watermark is present, the processor determines that an update may be made for the portion of the file (as described below for steps 802-808).

The processor then acquires watermark information from the watermark (step 802). For this operation, in some embodiments, the classification neural network (i.e., as used in step 800), another/different classification neural network, and/or another software application can be used to extract the watermark from the portion of the file. For example, in some embodiments, as part of determining that the watermark is present, the classification neural network returns the watermark as a result. The processor then processes the extracted watermark to determine words in text and/or other information from the watermark—which can be done in the neural network and/or using a recognition program (e.g., optical character recognition, etc.).

The processor then compares the watermark information to an information template to determine whether the watermark information matches the information template (step 804). For this operation, the processor determines whether the watermark information includes the same text, images, graphical objects, etc. For example, the processor may determine if the watermark information (i.e., the watermark itself) visually matches the information template. As another example, the processor may compare particular textual content, such as dates, accessing or creating entity identifiers, etc. found in the watermark information to textual content listed in the information template. When the watermark information matches the information template (step 806), the processor ends the process without changing the watermark in the portion of the file. In other words, when the watermark in the portion of the file sufficiently matches the information template, the watermark is left unchanged in the portion of the file. In this way, the processor “checks” the watermark and, finding the watermark satisfactory, leaves the watermark as is.

When the watermark information does not match the information template (step 806), the processor processes the portion of the file in a generative neural network to replace the watermark in the portion of the file with a given watermark (step 808). For this operation, the processor provides the portion of the file (or some part thereof) as an input to a generative neural network and performs the various operations of the neural network in order to generate a result in which the existing watermark from the portion of the file has been removed and replaced with the given watermark. For example, assuming the file is a digital presentation file slide (i.e., an image of the slide with text, images, etc.), the processor can acquire the slide from the digital presentation file and process the slide in the generative neural network to remove the existing watermark and replace the existing watermark with the given watermark. For instance, a company logo, a date, and/or textual content in the existing watermark in the presentation slide can be incorrect and the given watermark can include the desired company logo, date, and/or textual content. In some embodiments, the generative neural network is a fully connected neural network. In these embodiments, among the operations performed by the fully connected neural network are operations such as those described above.

In some embodiments, processing the portion of the file through the generative neural network to update the watermark includes retaining and/or recreating human visible information wholly or partially obscured by the existing watermark but not obscured by the given watermark in the portion of the file. In other words, where human visible information such as text, images, graphics, etc. was wholly or partially obscured by the existing watermark (e.g., text 104 and image 106 in FIG. 1), the generative neural network adds replacement human visible information so that the portion of the file appears correctly with the given watermark. The operations for retaining and/or recreating human visible information are similar to the operations for retaining and/or recreating human visible information when adding the watermark in FIG. 6 and therefore are not described in more detail.

Although a generative neural network might be used for replacing the watermark in the portion of the file as described above, in some embodiments, a different mechanism is used, or is used along with, the generative neural network for replacing the watermark in the portion of the file. For example, in some embodiments, the generative neural network removes the watermark from the portion of the file and then the processor provides the portion of the file (or some part thereof) as an input to a watermarking application and performs the operations of the watermarking application in order to add the watermark to the portion of the file. In some of these embodiments, the watermarking application is a software application in which the portion of the file was created. For example, assuming the portion of the file is a digital presentation file slide, the processor can acquire the slide from the digital presentation file and process the slide in a digital presentation application to add the watermark.

### Updating Watermarks in Multiple Portions of Files

In some embodiments, a file can include multiple portions. For example, a video file (possibly after decompression) may include a number of video frames (with each frame being a portion); a word processing document may include multiple pages, images, etc.; or a digital presentation file may have multiple slides, images, etc. In some of these embodiments, when performing operations for handling watermarks in a file with multiple portions, the operations described for FIGS. 5-8 can be performed for each portion individually. In some of these embodiments, however, certain operations for handling watermarks are performed for only a subset of the portions and the knowledge gained from the subset of the portions is extended to the remaining portions. For example, when processing watermarks in a digital presentation file, only a first (or a first few) slides in the file may be processed in the classification neural network to determine whether a watermark is present. The remaining slides in the file are assumed to match the first (or the first few) slides in the file—and subsequent operations such as adding a watermark, updating a watermark, etc. are performed based on this assumption. As another example, when processing watermarks in a digital video file, only a first (or a first few) frames in the file may be processed in the classification neural network to determine whether a watermark is present in some or all of the frames. Watermarking in the remaining frames in the file (e.g., which frames include watermarks, etc.) is assumed to match the first (or the first few) frames in the file—and subsequent operations such as adding a watermark, updating a watermark, etc. are performed based on this assumption.

### Security Settings

In some embodiments, before performing specified operations for handling watermarks in files, a processor in an electronic device (e.g., processor 402 in electronic device 400) performs security checks to ensure that the specified operations are permitted. For example, in some embodiments in which the processor removes watermarks from portions of files, the processor checks security settings (e.g., rules, guidelines, limitations, thresholds, etc.) to ensure that the watermarks are permitted to be removed from the portions of the files before removing the watermarks. For instance, an accessing entity may be identified to the processor (e.g., via configuration files, user input, etc.) so that the processor can compare the identified accessing entity to a list of permitted accessing entities to ensure that the accessing entity can access a portion of a file without the watermark. Upon finding that the accessing entity is permitted to access the portion of the file without the watermark, the processor determines that removing the watermark from the portion of the file is permitted. An example of this situation occurs when watermark is removed from an internal corporate document, presentation slide(s), and/or other files that are to be viewed by an employee, a corporate partner under a non-disclosure agreement, etc. In some embodiments, the security settings are provided by an administrator, received from another electronic device, etc.

### Operations for Specific Accessing Entities

In some embodiments, operations for handling watermarks in portions of files are based on information about specific accessing entities. For example, in some embodiments, updating a watermark such as in FIG. 8 is done so that the watermark matches a watermark to be presented to the accessing entity. In these embodiments, therefore, the information template to which the watermark information is compared includes text, graphical objects, etc. that are specific to the accessing entity—and the resulting watermark in the file (whether initially correct or replaced) is for the accessing entity. As an example, a digital presentation file may initially include a watermark on slides that is directed to a particular reader, such as an employee of company XYZ, but after the updating, the watermark on the slides is directed to a desired reader, such as an employee of company DGE. In this way, using the operations described herein, a watermark in a portion of a file can be updated and customized for a specific accessing entity. In some of these embodiments, these updates are performed on the fly, i.e., just before the portion of the file is presented to the accessing entity. For example, an accessing entity can request to view a video and the electronic device herein described can add, remove, and/or replace watermark(s) in the video file just before streaming the video file to the accessing entity.

In some embodiments, specified operations for a portion of a file are blocked until the portion of a file can be permissibly presented to an accessing entity. For example, in some embodiments, the updating and/or adding of a watermark to a portion of a file is done as an extension of an email application. In these embodiments, an email to which a portion of a file is attached may not be permitted to send to an accessing entity until a watermark is verified in the portion of the file—i.e., checked and added/replaced in the portion of the file if necessary. In some of these embodiments, the verification of watermarks occurs “in the background” and in a way that is invisible to users.

In some embodiments, at least one electronic device (e.g., electronic device 400, etc.) uses code and/or data stored on a non-transitory computer-readable storage medium to perform some or all of the operations described herein. More specifically, the at least one electronic device reads code and/or data from the computer-readable storage medium and executes the code and/or uses the data when performing the described operations. A computer-readable storage medium can be any device, medium, or combination thereof that stores code and/or data for use by an electronic device. For example, the computer-readable storage medium can include, but is not limited to, volatile and/or non-volatile memory, including flash memory, random access memory (e.g., eDRAM, RAM, SRAM, DRAM, etc.), non-volatile RAM (e.g., phase change memory, ferroelectric random access memory, spin-transfer torque random access memory, magnetoresistive random access memory, etc.), read-only memory (ROM), and/or magnetic or optical storage mediums (e.g., disk drives, magnetic tape, CDs, DVDs, etc.).

In some embodiments, one or more hardware modules perform the operations described herein. For example, the hardware modules can include, but are not limited to, one or more central processing units (CPUs)/CPU cores, graphics processing units (GPUs)/GPU cores, application-specific integrated circuit (ASIC) chips, field-programmable gate arrays (FPGAs), compressors or encoders, encryption functional blocks, compute units, embedded processors, accelerated processing units (APUs), neural network processors, controllers, network communication links/devices, and/or other functional blocks. When circuitry (e.g., integrated circuit elements, discrete circuit elements, etc.) in such hardware modules is activated, the circuitry performs some or all of the operations. In some embodiments, the hardware modules include general purpose circuitry such as execution pipelines, compute or processing units, etc. that, upon executing instructions (e.g., program code, firmware, etc.), performs the operations. In some embodiments, the hardware modules include purpose-specific or dedicated circuitry that performs the operations “in hardware” and without executing instructions.

In some embodiments, a data structure representative of some or all of the functional blocks and circuit elements described herein (e.g., electronic device 400, or some portion thereof) is stored on a non-transitory computer-readable storage medium that includes a database or other data structure which can be read by an electronic device and used, directly or indirectly, to fabricate hardware including the functional blocks and circuit elements. For example, the data structure may be a behavioral-level description or register-transfer level (RTL) description of the hardware functionality in a high-level design language (HDL) such as Verilog or VHDL. The description may be read by a synthesis tool which may synthesize the description to produce a netlist including a list of transistors/circuit elements from a synthesis library that represent the functionality of the hardware including the above-described functional blocks and circuit elements. The netlist may then be placed and routed to produce a data set describing geometric shapes to be applied to masks. The masks may then be used in various semiconductor fabrication steps to produce a semiconductor circuit or circuits (e.g., integrated circuits) corresponding to the above-described functional blocks and circuit elements. Alternatively, the database on the computer accessible storage medium may be the netlist (with or without the synthesis library) or the data set, as desired, or Graphic Data System (GDS) II data.

In this description, variables or unspecified values (i.e., general descriptions of values without particular instances of the values) are represented by letters such as N, M, and X. As used herein, despite possibly using similar letters in different locations in this description, the variables and unspecified values in each case are not necessarily the same, i.e., there may be different variable amounts and values intended for some or all of the general variables and unspecified values. In other words, particular instances of N and any other letters used to represent variables and unspecified values in this description are not necessarily related to one another.

The expression “et cetera” or “etc.” as used herein is intended to present an and/or case, i.e., the equivalent of “at least one of” the elements in a list with which the etc. is associated. For example, in the statement “the electronic device performs a first operation, a second operation, etc.,” the electronic device performs at least one of the first operation, the second operation, and other operations. In addition, the elements in a list associated with an etc. are merely examples from among a set of examples—and at least some of the examples may not appear in some embodiments.

The foregoing descriptions of embodiments have been presented only for purposes of illustration and description. They are not intended to be exhaustive or to limit the embodiments to the forms disclosed. Accordingly, many modifications and variations will be apparent to practitioners skilled in the art. Additionally, the above disclosure is not intended to limit the embodiments. The scope of the embodiments is defined by the appended claims.

What is claimed is:

1. An electronic device, comprising:
a processor configured to:
process a portion of a file in a classification neural network to determine whether a watermark is present in the portion of the file;
based on a result of the processing, perform an update associated with the watermark in the portion of the file; and
provide the updated portion of the file.

2. The electronic device of claim 1, wherein, when the watermark is determined to be present in the portion of the file, for performing the update, the processor is configured to:
process the portion of the file in a generative neural network to remove the watermark from the portion of the file.

3. The electronic device of claim 2, wherein the processor is further configured to:
check one or more security settings to ensure that the watermark is permitted to be removed from the portion of the file before removing the watermark.

4. The electronic device of claim 2, wherein removing the watermark from the portion of the file includes retaining and/or recreating human visible information obscured by the watermark in the portion of the file.

5. The electronic device of claim 1, wherein, when the watermark is determined to be present in the portion of the file, for performing the update, the processor is configured to:
acquire watermark information from the watermark;
compare the watermark information to an information template to determine whether the watermark information matches the information template; and
when the watermark information does not match, process the portion of the file in a generative neural network to replace the watermark with a given watermark.

6. The electronic device of claim 1, wherein, when a watermark is determined not to be present in the portion of the file, for performing the update, the processor is configured to:
process the portion of the file in a generative neural network to add a given watermark to the portion of the file; or
process the portion of the file in a watermarking application to add a given watermark to the portion of the file.

7. The electronic device of claim 6, wherein the watermark includes information configured for one or more accessing entities that will subsequently have access to the file.

8. The electronic device of claim 1, wherein the portion of the file includes:
one or more document pages in the file;
one or more video frames in the file; or
one or more images in the file.

9. The electronic device of claim 1, wherein the processor is further configured to receive the classification neural network from an external source, the classification neural network having been trained to determine the presence of the watermark in the portion of the file.

10. The electronic device of claim 1, wherein the processor is further configured to:
after updating the portion of the file, update one or more other portions of the file based at least in part on the update to the portion of the file without processing the one or more other portions of the file in the classification neural network.

11. A method for handling watermarks in files, the method comprising:
processing a portion of a file in a classification neural network to determine whether a watermark is present in the portion of the file;
based on a result of the processing, performing an update associated with the watermark in the portion of the file; and
providing the updated portion of the file.

12. The method of claim 11, wherein, when the watermark is determined to be present in the portion of the file, performing the update includes:
processing the portion of the file in a generative neural network to remove the watermark from the portion of the file.

13. The method of claim 12, further comprising:
checking one or more security settings to ensure that the watermark is permitted to be removed from the portion of the file before removing the watermark.

14. The method of claim 12, wherein removing the watermark from the portion of the file includes retaining and/or recreating human visible information obscured by the watermark in the portion of the file.

15. The method of claim 11, wherein, when the watermark is determined to be present in the portion of the file, performing the update includes:
acquiring watermark information from the watermark;
comparing the watermark information to an information template to determine whether the watermark information matches the information template; and
when the watermark information does not match, processing the portion of the file in a generative neural network to replace the watermark with a given watermark.

16. The method of claim 11, wherein, when a watermark is determined not to be present in the portion of the file, performing the update includes:
processing the portion of the file in a generative neural network to add a given watermark to the portion of the file; or
processing the portion of the file in a watermarking application to add a given watermark to the portion of the file.

17. The method of claim 16, wherein the watermark includes information configured for one or more accessing entities that will subsequently have access to the file.

18. The method of claim 11, wherein the portion of the file includes:
one or more document pages in the file;
one or more video frames in the file; or
one or more images in the file.

19. The method of claim 11, further comprising:
receiving the classification neural network from an external source, the classification neural network having been trained to determine the presence of the watermark in the portion of the file.

20. The method of claim 11, further comprising:
after updating the portion of the file, updating one or more other portions of the file based at least in part on the update to the portion of the file without processing the one or more other portions of the file in the classification neural network.
